(19) United States
(12) Patent Application Publication
(10) Pub. No.: US 2012/0314892 A1
(43) Pub. Date: Dec. 13, 2012

(54) HEARING APPARATUS HAVING A SENSOR UNIT AND METHOD OF OPERATING THE HEARING APPARATUS

(75) Inventors: PhanHow Amy CHENG, SINGAPORE (SG); Cheoung Hong LEE, SINGAPORE (SG); Meng Kiang LIM, SINGAPORE (SG)

(73) Assignee: SIEMENS MEDICAL INSTRUMENTS PTE. LTD., SINGAPORE (SG)

(21) Appl. No.: 13/410,870

(22) Filed: Mar. 2, 2012

(30) Foreign Application Priority Data
Mar. 2, 2011 (DE) 10 2011 004 966.5

(51) Int. Cl. H04R 25/00

(52) U.S. Cl. 381/321

(57) ABSTRACT

A hearing apparatus has an input converter for converting an input signal into an electrical signal, an amplifier for amplifying the electrical signal and an output converter for converting the amplified electrical signal into an output signal, and a battery compartment, into which a battery for supplying electrical energy at least to the amplifier can be introduced. The hearing apparatus further has a sensor unit, which is embodied to detect a position of the battery compartment in a contactless fashion and to output signals as a function thereof, by which the hearing apparatus can be switched on or off.

### CROSS-REFERENCE TO RELATED APPLICATION

This application claims the priority, under 35 U.S.C. §119, of German application DE 10 2011 004 966.5, filed Mar. 2, 2011; the prior application is herewith incorporated by reference in its entirety.

### BACKGROUND OF THE INVENTION

### Field of the Invention

The invention relates to a hearing apparatus having an input converter for converting an input signal into an electrical signal, an amplifier for amplifying the electrical signal and an output converter for converting the amplified electrical signal into an output signal, as well as a battery compartment into which a battery for supplying electrical energy at least to the amplifier can be introduced. The invention also relates to a method for switching a hearing apparatus on and/or off.

Hearing devices are wearable hearing apparatuses which are used to supply the hard-of-hearing. To accommodate the numerous individual requirements, different configurations of hearing devices such as behind-the-ear hearing devices (BTE), hearing device with an external receiver (RIC: receiver in the canal) and in-the-ear hearing devices (ITE), e.g. also concha hearing devices or canal hearing devices (ITE—in-the-ear, CIC—completely in the canal) are provided. The hearing devices given by way of example are worn on the outer ear or in the auditory canal. Furthermore, bone conduction hearing aids, implantable or vibrotactile hearing aids are also available on the market. In such cases the damaged hearing is stimulated either mechanically or electrically.

Essential components of the hearing devices include in principle an input converter, an amplifier and an output converter. The input converter is generally a recording converter, e.g. a microphone and/or an electromagnetic receiver, e.g. an induction coil. The output converter is mostly realized as an electro-acoustic converter, e.g. a miniature loudspeaker, or as an electromechanical converter, e.g. a bone conduction receiver. The amplifier is usually integrated into a signal processing unit. This basic structure is shown in the example in FIG. 1 of a behind-the-ear hearing device 6. One or more microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is supplied by a battery 5 which is likewise integrated into the hearing device housing 1.

The battery 5 is generally accommodated in a battery compartment 7, which can be pivoted within the housing of the hearing device 6 or can be completely detached therefrom. The hearing device 6 is herewith usually switched off such that an electrical contact between the battery 5 and the electronic components of the hearing device 6 to be supplied with power (for instance the signal processing unit 3) is interrupted. This takes place by pivoting, pulling or otherwise moving the battery compartment 7.

The battery compartment 7 is herewith usually embodied from plastic, whereas the contact to the battery 5 is established by way of a metal part. This involves friction between the plastic material of the battery compartment 7 and the metal contact, so that plastic is worn away from the battery compartment 7 with a frequent switching on and off. Damage to the battery compartment 7 may herewith occur, whereby when the plastic is severely worn away from the battery compartment 7, there is no longer any guarantee that the contact for switching the hearing device 6 on and/or off can be activated. In addition, further irreversible damage to the battery compartment 7, e.g. cracks, may occur.

U.S. patent publication No. 2008/0232622 A1 discloses a hearing device with a battery compartment, whereby a switch for switching the hearing device on and off is integrated into the battery compartment. If pressure is exerted onto the switch, a spring element deforms and shuts off an electrical contact with the battery. A current circuit is herewith closed and the hearing device is activated.

U.S. Pat. No. 5,687,242 likewise describes a battery compartment of a hearing device, whereby by closing the battery compartment, an electrical contact between two electrodes is also automatically shut off, of which one is attached to a battery compartment cover and one is attached to a battery compartment housing. By closing the contact, the hearing device is switched on.

U.S. Pat. No. 5,995,636 discloses a hearing aid device with a battery compartment containing a battery and a cover closing the battery compartment and hinged to the housing. The hearing aid device contains control logics and a contact arrangement which can be actuated by pressure on the cover found in the closed position, by which contact arrangement the control logic can be activated.

### SUMMARY OF THE INVENTION

It is accordingly an object of the invention to provide a hearing apparatus having a sensor unit and a method of operating the hearing apparatus which overcome the above-mentioned disadvantages of the prior art methods and devices of this general type, with the aid of which the hearing apparatus can be switched on and off with reduced wear. A reliable switching on and off and a long service life of the hearing apparatus are thereby ensured.

The inventive hearing apparatus includes an input converter for converting an input signal into an electrical signal, an amplifier for amplifying the electrical signal and an output converter for converting the amplified electrical signal into an output signal, as well as a battery compartment, into which a battery for supplying electrical energy at least to the amplifier can be introduced. Finally, the inventive hearing apparatus also includes a sensor unit, which is embodied to detect a position of the battery compartment in a contactless manner and as a function thereof to output signals, by which the hearing apparatus can be switched on and/or off.

The battery compartment may in particular be embodied to be moveable so that an operating person is able to effect a switching on and/or off of the hearing apparatus by choosing the position of the battery compartment. The battery compartment can in particular itself then assume the function of an actuatable switch. The battery compartment may in particular be embodied in the hearing apparatus so as to move in an oscillating fashion, whereby two target positions can be provided, with a first target position which corresponds to an on state and a second target position which corresponds to an off state. The sensor unit may then be embodied in particular so as to detect these respective states as such and to provide suitable electrical signals, which effect a switching on and/or off of the hearing apparatus. The term “contactless detection” is in particular to be understood to mean that the battery compartment and sensor unit are not in direct mechanical and/or electrical contact with one another. Provision can however be made for the battery compartment to be actuatable by an operating person by touch in order to activate an on and/or off state.

In a thus embodied hearing apparatus, there is no direct mechanical contact between the sensor unit and the battery compartment, so that with a switching on and/or off process, both elements exert no mechanical friction on one another. Wear and abrasion are reliably prevented. Even a frequent actuation of the on and off function does not result in any permanent mechanical impairments to the switching arrangement. The service life of the hearing apparatus overall and in particular of the battery compartment is considerably lengthened. Defects are prevented and a wear-free, robust and less fault-prone hearing apparatus is provided. This is of significant importance since hearing-impaired persons are if necessary permanently dependent on their hearing aid and even only a brief failure of the hearing apparatus would result in considerable impairments to the quality of life of the hearing-impaired person.

A trigger element is preferably arranged on the battery compartment, with which the sensor unit interacts in such a way that it triggers the sensor unit to output the signals. The sensor unit and trigger element can then interact with one another in particular like a piece and counter piece and ensure a reliable switching on and off of the hearing apparatus. In particular, provision can be made for the battery compartment to be embodied from a simple and cost-effective plastic material, while the trigger element consists of a suitable material, with which the sensor unit can be activated. The trigger element may in particular be embodied from metal, a magnetic material and/or an optically reflecting material. Provision can in particular be made for the trigger element and sensor unit to have no direct mechanical contact with one another in any operating position of the battery compartment. A trigger element which is selected so as to correspond to the sensor unit ensures that in accordance with the physical functional principle of the sensor unit, a reliable trigger is always ensured irrespective of the material of the battery compartment. The detection sensitivity of the sensor unit is improved by the trigger element.

The sensor unit and the trigger element are arranged in such a way that in the event of the presence of a pre-determinable relative distance and/or a predeterminable relative orientation of the sensor unit and trigger element, the sensor unit is triggered to output the signals. The sensor unit and trigger element can therefore have different active contact with one another as a function of their relative orientation and/or as a function of their relative distance from one another. In particular, provision can be made for the sensor unit not to supply any signal if the trigger element is very far removed from the sensor unit, whereas a signal is then output if the trigger element is closer to the sensor unit. A rotation and/or tilting and/or pivoting of the trigger element may, by way of a suitable physical mechanism, result in the sensor unit being triggered to output signals. The combination of a relative position of two elements with an on and off functionality is intuitively easy to understand for an operating person and accordingly particularly suited to switching on and/or off.

The hearing apparatus preferably includes a housing, to which the battery compartment is fastened. The battery compartment may in particular be hinged to the housing so as to move in an oscillating fashion. It may however also be arranged on the housing in a retractable/extractable manner. Two retractable target positions may in particular be provided, of which one represents a switch position “ON” and the other represents a switch position “OFF”. The switching on and off of the hearing apparatus is then particularly user-friendly.

The sensor unit is preferably arranged in the housing of the hearing apparatus. It is then particularly well protected from dirt and damage and an unwanted triggering of the sensor unit can be prevented. A compact and highly-integrated hearing apparatus results with electronic components which are outwardly only slightly visible.

The sensor unit is preferably arranged on a printed circuit board, which at least partially includes in particular the amplifier. This embodiment is particularly limiting in terms of components and is thus cost-effective. In particular, if a printed circuit board is used for the sensor unit, on which printed circuit board the amplifier is already located, redundancy is avoided and a component which is already provided is used. In addition, allowance is made for the restricted space available in the hearing apparatus.

The sensor unit is preferably based on a capacitive detection principle. The trigger element can then be embodied in particular metallically, so that if the trigger element approaches the sensor unit, a capacity change in the thus embodied capacitor arrangement is detected. Alternatively or in addition, provision can be made for the sensor unit to be based on an inductive detection principle. Provision can then be made for instance for the trigger element to be embodied as a permanent magnet and the sensor unit to be embodied as a coil. When the trigger element approaches the sensor unit, an induced current can be detected in the sensor unit and trigger the output of the on and off signal. Alternatively or in addition, provision can be made for the sensor unit to be based on a magnetic detection principle. Finally, provision can alternatively or additionally be made for the sensor unit to be based on an optical detection principle. By way of example, the sensor unit can then be embodied as a photodiode and the trigger element can be embodied with an optically reflecting layer. These detection principles are in principle easy, technically unproblematic to implement and consequently very precise.

The hearing apparatus is preferably embodied as a behind-the-ear hearing device.

The inventive method is used to switch on and/or off a hearing apparatus having an input converter for converting an input signal into an electrical signal, an amplifier for amplifying the electrical signal and an output converter for converting the amplified electrical signal into an output signal, as well as a battery compartment, into which the battery for supplying electrical energy at least to the amplifier can be introduced. The inventive method includes the following steps: contactless detection of a position of the battery compartment by a sensor unit; and in dependence on a detected position, outputting signals, by which the hearing apparatus can be switched on and/or off, by the sensor unit.

Other features which are considered as characteristic for the invention are set forth in the appended claims.

Although the invention is illustrated and described herein as embodied in a hearing apparatus having a sensor unit and a method of operating the hearing apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic representation of a structure of a hearing device according to the prior art;

FIG. 2 is a diagrammatic, partially cut-way perspective view of the hearing device with a sensor unit which operates in a contactless fashion according to the invention;

FIG. 3 is a perspective, enlarged view of a framed cutout of the hearing device shown in FIG. 2;

FIG. 4 is a diagrammatic, perspective view of a printed circuit board with a sensor;

FIG. 5 is a diagrammatic, perspective view of a battery compartment with a trigger element;

FIG. 6 is an illustration of a cutout of the hearing device with the battery compartment in an “ON” position;

FIG. 7 is an illustration of an enlarged representation of the framed cutout shown in FIG. 6, whereby the sensor and trigger element come to lie opposite one another;

FIG. 8 is an illustration of the cutout of the hearing device with the battery compartment in an “OFF” position; and

FIG. 9 is an illustration of an enlarged representation of the framed cutout in FIG. 8, whereby the sensor and trigger element do not come to lie opposite one another.

### DETAILED DESCRIPTION OF THE INVENTION

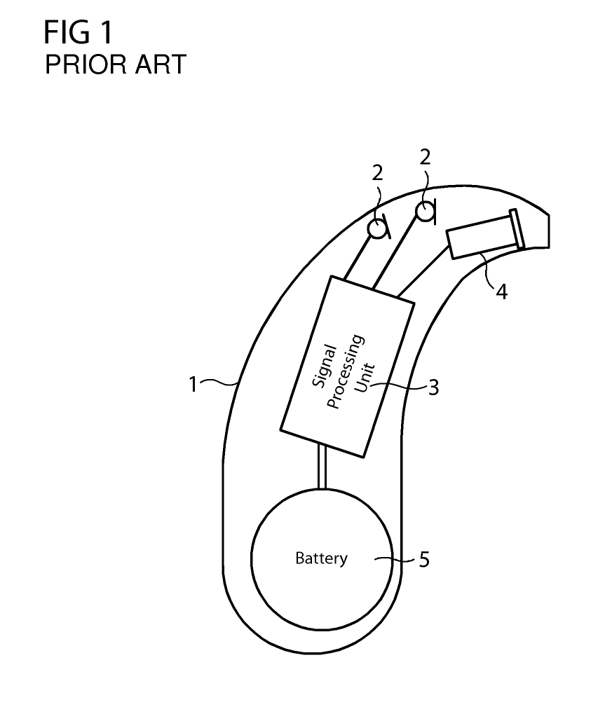

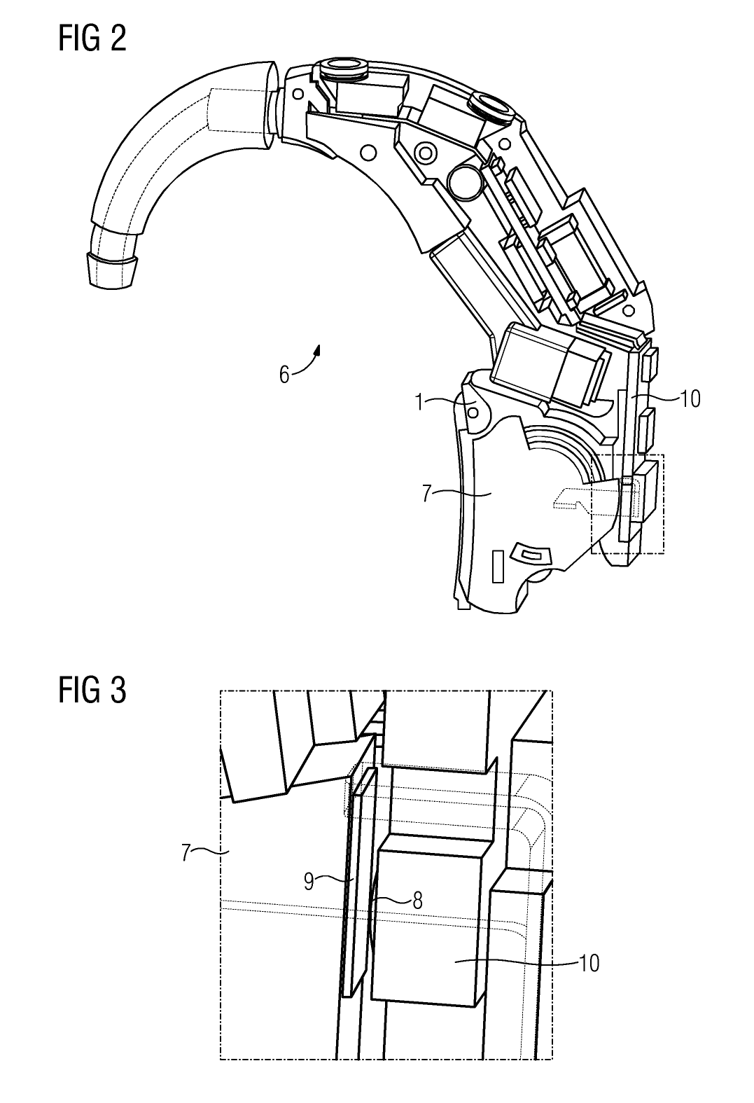

Identical or functionally-identical elements are provided with the same reference characters in the figures. Referring now to the figures of the drawing in detail and first, particularly, to FIG. 2 thereof, there is shown a development of the hearing device shown in FIG. 1. The on and off functionality is provided on the lower end of the hearing device 6 by a pivotably hinged battery compartment 7 and a printed circuit board 10 which is fixedly installed in the hearing device housing 1.

FIG. 3 shows the framed cutout in FIG. 2 in an enlarged representation. It is apparent that a trigger element 9 is fixedly arranged on the battery compartment 7 which is embodied from plastic. This lies opposite a sensor 8 which is found on the printed circuit board 10. The sensor 8 and the trigger element 9 are not in direct electrical or mechanical contact with one another. They interact in a contactless fashion.

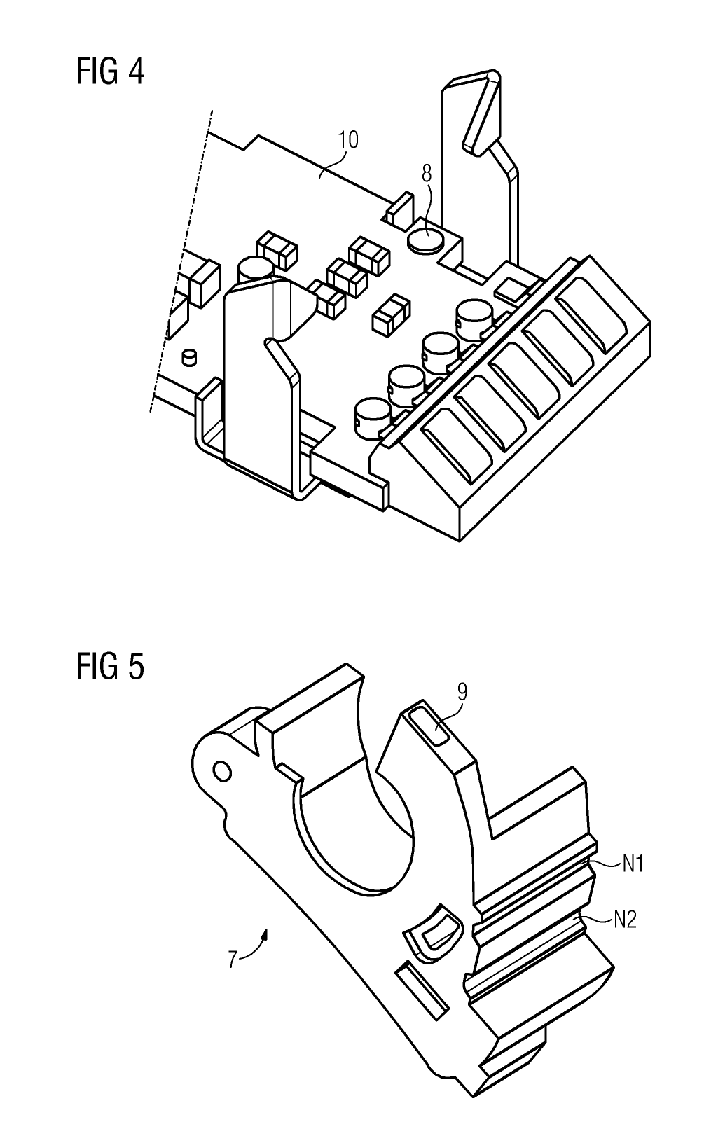

As can be inferred more precisely from FIG. 4, the sensor 8 is embodied relatively small on the printed circuit board 10 and is fixedly connected thereto. The sensor 8 is one of several components of the integrated circuit of the printed circuit board 10. Sufficient space is available on the printed circuit board 10 for its variable positioning.

FIG. 5 shows the battery compartment 7, which is embodied to receive one or several batteries 5 (e.g. coil cells). The trigger element 9 is attached on one side of this battery compartment 7 (e.g. by adhesion).

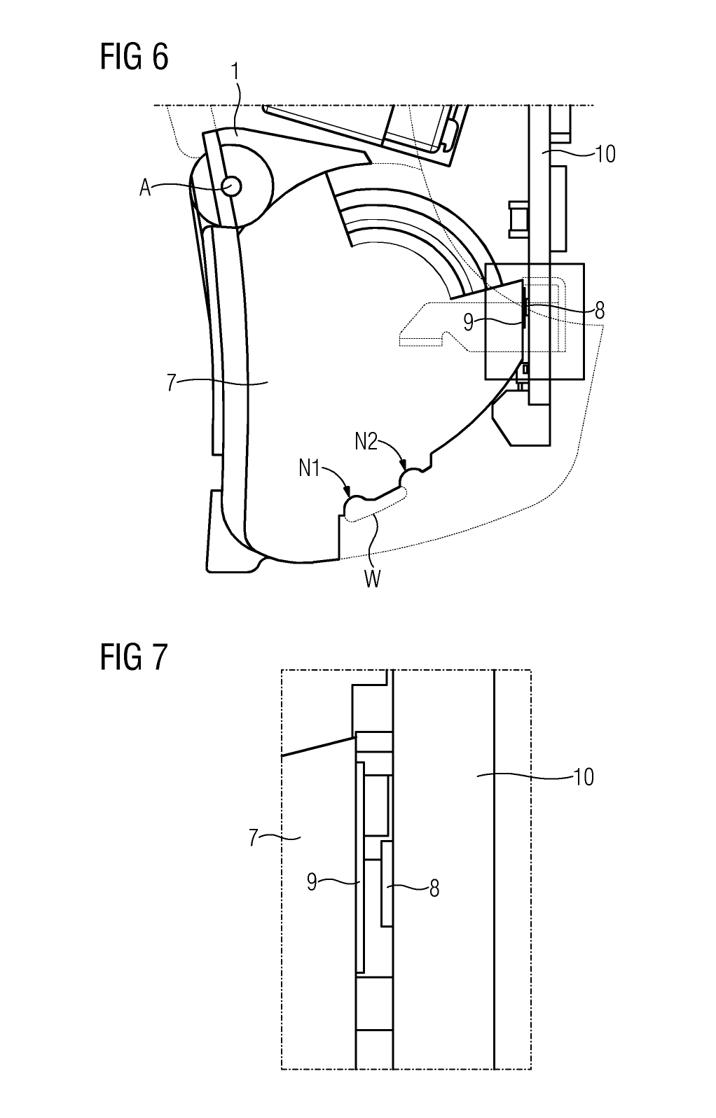

If the components shown in FIG. 4 and FIG. 5 are installed in the hearing device 6, the arrangement shown in FIG. 6 results. The battery compartment 7 is hinged to the hearing device housing 1 so as to move in an oscillating fashion about an axis A. The battery compartment 7 is held in position by the interaction of a protrusion W provided in the hearing device housing 1 with a groove N1 provided in the battery compartment 7. In this position, the sensor 8 and trigger element 9 come to lie very closely opposite to one another. This is also clearly apparent from FIG. 7. The hearing device 6 is then found in a switched-on state.

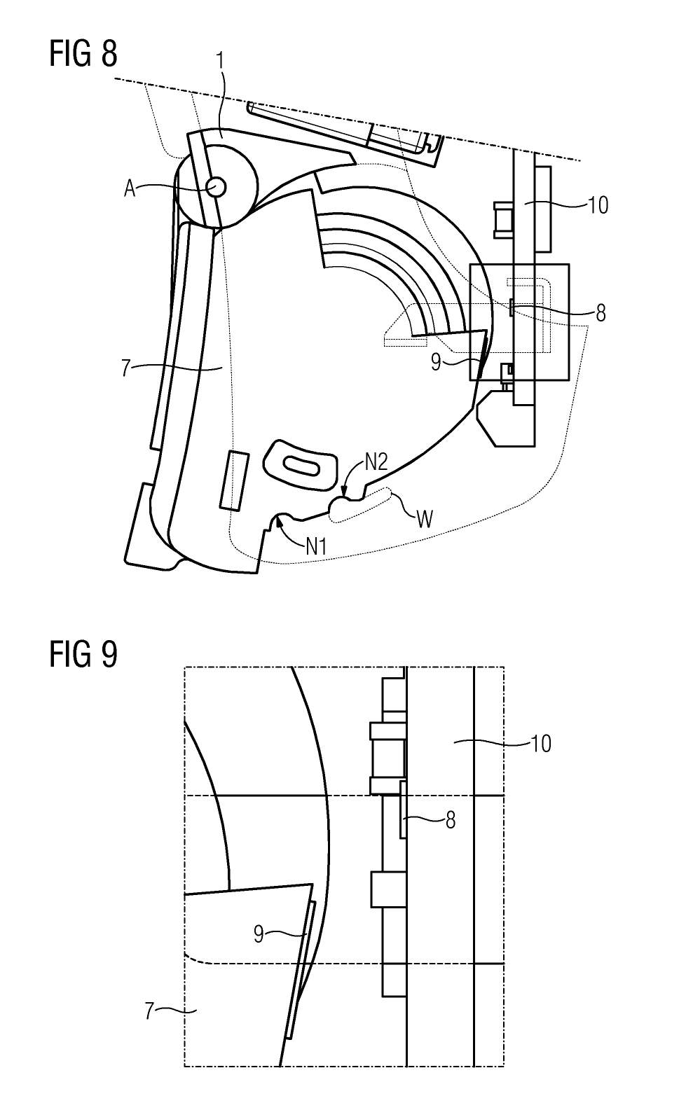

If an operating person would now like to switch the hearing device off, he/she can grip the battery compartment 7 and this pivots around the axis A as shown in FIG. 8. The battery compartment 7 engages in a second target position which is defined by interaction of the protrusion W with a second groove N2. As can be inferred in particular from FIG. 9, in this position the sensor 8 and the trigger element 9 can no longer come to lie opposite one another. Compared with the arrangement in FIG. 7, the relative distance between the sensor 8 and trigger element 9 is enlarged; in addition the relative orientation of both elements has changed with respect to one another. This in turn means that the sensor unit 8 outputs a signal, with which the hearing device 6 is switched off (i.e. electrical consumers are deactivated and/or separated from the battery 5 as load).

If the operating person would like to switch the hearing device 6 on again, then he/she must only press the battery compartment 7 back into the position shown in FIG. 6. The trigger element 9 then once again approaches the sensor 8. The sensor 8 and trigger element 9 now interact in such a way that the change in the relative distance of both components brings about a signal trigger in the sensor unit 8. The signal output by the sensor 8 then in turn results in the hearing device 6 switching on.

One distinctive feature consists in no direct mechanical and/or electrical contact existing between the sensor 8 and trigger element 9, thereby ensuring that they do not rub against one another when pivoting the battery compartment 7. Unwanted abrasion of material and thus in conjunction therewith wear are subsequently avoided. A reliable on and off functionality of the hearing device 6 is permanently provided.

1. A hearing apparatus, comprising:
an input converter for converting an input signal into an electrical signal,
an amplifier for amplifying the electrical signal into an amplified electric signal;
an output converter for converting the amplified electrical signal into an output signal;
a battery compartment, into which a battery for supplying electrical energy at least to said amplifier can be introduced; and
a sensor unit for detecting a position of said battery compartment in a contactless fashion and to output signals in dependence thereof, by means of which the hearing apparatus can be switched on or off.

2. The hearing apparatus according to claim 1, further comprising a trigger element disposed on said battery compartment, with which said sensor unit interacts in such a way that said trigger element triggers said sensor unit to output the signals.

3. The hearing apparatus according to claim 2, wherein said sensor unit and said trigger element are disposed in such a way that in an event of a presence of a pre-determinable relative distance and/or a pre-determinable relative orientation of said sensor unit and said trigger element, said sensor unit is triggered to output the signals.

4. The hearing apparatus according to claim 1, further comprising a housing, to which said battery compartment is fastened.

5. The hearing apparatus according to claim 4, wherein said sensor unit is disposed in said housing.

6. The hearing apparatus according to claim 1, further comprising a printed circuit board, said sensor unit is disposed on said printed circuit board, which at least partially includes said amplifier.

7. The hearing apparatus according to claim 1, wherein said sensor unit is based on at least one of a capacitive detection principle, an inductive detection principle, a magnetic detection principle or an optical detection principle.

8. The hearing apparatus according to claim 1, wherein the hearing device is a behind-the-ear hearing device.

9. A method for switching on or off a hearing apparatus having an input converter for converting an input signal into an electrical signal, an amplifier for amplifying the electrical signal and an output converter for converting an amplified electrical signal into an output signal, and a battery compartment, into which a battery for supplying electrical energy at least to the amplifier can be introduced, which comprises the steps of:
contactlessly detecting a position of the battery compartment via a sensor unit; and
outputting signals, by means of which the hearing apparatus can be switched on or off, by the sensor unit in dependence on a detected position.
